(19) United States
(12) Patent Application Publication
(10) Pub. No.: US 2026/0175501 A1
(43) Pub. Date: Jun. 25, 2026

(54) MOLDING SUPPORTING DEVICE AND MOLDING MACHINE

(71) Applicant: SUMITOMO HEAVY INDUSTRIES, LTD., Tokyo (JP)

(72) Inventors: Daigo HOTTA, Chiba-shi (JP); Tomosuke KADOONO, Chiba-shi (JP); Atsuro TAMURA, Chiba-shi (JP)

(21) Appl. No.: 19/317,924

(22) Filed: Sep. 3, 2025

(30) Foreign Application Priority Data
Dec. 19, 2024 (JP) 2024-223794

(51) Int. Cl. B29C 45/76

(52) U.S. Cl. CPC B29C 45/766; B29C 2945/76939

(57) ABSTRACT

A molding supporting device includes: a purpose information acquisition unit that acquires purpose information indicating a purpose of work with respect to a molding device; an operation information acquisition unit that acquires operation information indicating an operation of a worker in the work; and a writing unit that writes the operation information acquired by the operation information acquisition unit in association with the purpose information acquired by the purpose information acquisition unit to a storage unit.

### CROSS-REFERENCE TO RELATED APPLICATIONS

This application claims priority to Japanese Patent Application No. 2024-223794, filed on December 19, 2024, which is incorporated by reference herein in its entirety.

### BACKGROUND

### TECHNICAL FIELD

A certain embodiment of the present invention relates to a molding supporting device and a molding machine.

### DESCRIPTION OF RELATED ART

The related art discloses a display method of a setting screen. In this display method, a predetermined setting screen is formed on a display part based on an operation of an operation unit performed by an operator. In addition, in this display method, in a case where a predetermined setting item of molding conditions is selected by the operator and a confirmation operation element is pressed, a guidance screen is formed in a part of a region of the setting screen corresponding to the setting item. Further, in this display method, guidance information is read out from a recording unit and is displayed on the guidance screen.

The related art discloses a setting supporting method for an injection molding machine. As a basic concept of the setting supporting method, it is described that resin material data Dr … relating to a resin decomposition ratio Sx with respect to a temperature Ht, which corresponds to the type of the resin material, is set in advance as a database in a molding machine controller.

### SUMMARY

According to an embodiment of the present invention, there is provided a molding supporting device including a purpose information acquisition unit that acquires purpose information indicating a purpose of work with respect to a molding device, an operation information acquisition unit that acquires operation information indicating an operation of a worker in the work, and a writing unit that writes the operation information acquired by the operation information acquisition unit in association with the purpose information acquired by the purpose information acquisition unit to a storage unit.

In addition, according to an embodiment of the present invention, there is provided a molding supporting device including a reading unit that reads, from a storage unit that stores operation information indicating an operation of a worker in work with respect to a molding device in association with purpose information indicating a purpose of the work, the operation information associated with the purpose information, and an output unit that outputs the operation information read by the reading unit or derivation information derived from the operation information.

Furthermore, according to an embodiment of the present invention, there is provided a molding machine including any one of the above molding supporting devices, the molding device, and a control device that controls the molding device.

Furthermore, according to an embodiment of the present invention, there is provided a molding supporting device including an acquisition unit that acquires association information in which purpose information indicating a purpose of work with respect to a molding device and operation information indicating an operation of a worker in the work are associated with each other, and a writing unit that writes the association information acquired by the acquisition unit to a storage unit.

### BRIEF DESCRIPTION OF THE DRAWINGS

FIG. 1 is a view showing a configuration of an injection molding machine to which the present embodiment is applied.

FIG. 2 is a view showing a configuration of a control device.

FIG. 3 is a view showing a configuration of a data processing device.

FIG. 4 is a view showing a configuration of a molding supporting device.

FIG. 5 is a view showing a hardware configuration example of a computer that realizes a control device, a data processing device, and a molding supporting device.

FIG. 6 is a view showing an example of a flow of operation information collection processing performed by an operation information collection device.

FIG. 7 is a view showing an example of a flow of operation information providing processing performed by an operation information providing device.

FIGS. 8A and 8B are views showing a screen displayed on a display unit.

### DETAILED DESCRIPTION

In the molding machine of the related art, a configuration for collecting or providing an operation of a worker in association with a purpose of the work has not been adopted. For example, a configuration for collecting or providing an operation of the worker in association with a problem to be resolved or a problem resolved in the past has not been adopted. Therefore, in the molding machine of the related art, it is not possible to increase a likelihood of improving work efficiency of the worker or transferring technical know-how at a work site.

It is desirable to increase the likelihood of improving the work efficiency of the worker or transferring the technical know-how at the work site.

The molding supporting device may further include an attribute information acquisition unit that acquires attribute information indicating an attribute of the work, in which the writing unit may write the operation information in further association with the attribute information acquired by the attribute information acquisition unit to the storage unit. In this case, the attribute information may indicate at least one of an attribute of the work itself, an attribute of the worker, and an attribute of a place where the work is performed.

The reading unit may read, from the storage unit that stores the operation information in further association with attribute information indicating an attribute of the work, the attribute information associated with the operation information, and the output unit may output the operation information or the derivation information by using the attribute information read by the reading unit. In this case, the attribute information may indicate at least one of an attribute of the work itself, an attribute of the worker, and an attribute of a place where the work is performed. In addition, the output unit may output the attribute information read by the reading unit in association with the operation information or the derivation information. Furthermore, the output unit may output the derivation information derived from the operation information based on the attribute information read by the reading unit.

The output unit may output the derivation information which is a result of machine learning performed on the operation information.

The output unit may further output the information indicating an amount of operation information.

Hereinafter, an embodiment of the present invention will be described in detail with reference to the accompanying drawings.

### DEVICE CONFIGURATION

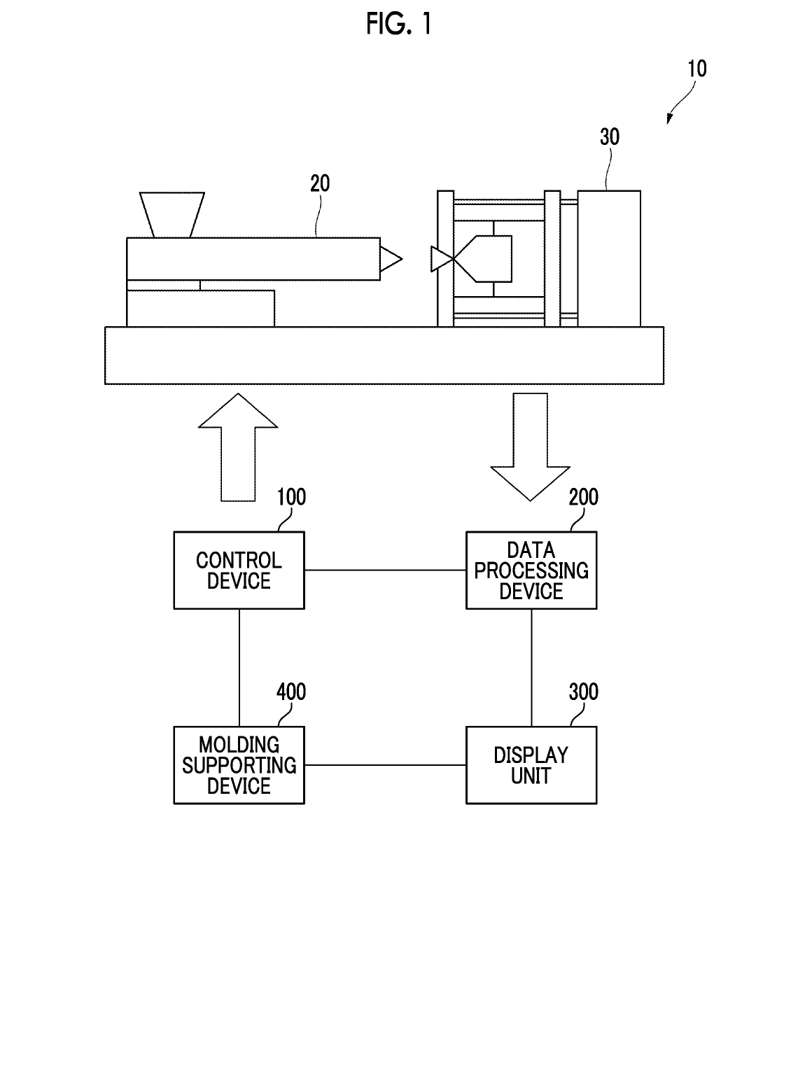

FIG. 1 is a view showing a configuration of an injection molding machine 10 to which the present embodiment is applied. The injection molding machine 10 includes an injection unit 20, a mold clamping unit 30, a control device 100, a data processing device 200, a display unit 300, and a molding supporting device 400. In the following description, a direction from the injection unit 20 toward the mold clamping unit 30 may be referred to as a front. The injection molding machine 10 is an example of a molding machine. The injection unit 20 and the mold clamping unit 30 are examples of a molding device.

The injection unit 20 is configured with a cylinder that heats a molding material, a screw that is rotatable in the cylinder and that is capable of advancing and retreating in an axial direction, a rotary motor that drives the screw in a rotation direction, a motor that drives the screw in the axial direction, and the like. The molding material is, for example, a resin. The injection unit 20 injects the molding material that is heated and liquefied in the cylinder by advancing the screw in a front direction while rotating the screw, and fills a mold of the mold clamping unit 30 disposed in front of the injection unit 20. The injection unit 20 performs, for example, a plasticizing process, a filling process, a pressure holding process, or the like in a manufacturing process of a molding product. The filling process and the pressure holding process may be collectively referred to as an injection process.

The mold clamping unit 30 includes the mold, a clamping mechanism that clamps the mold, a motor that drives the clamping mechanism, and the like. The mold clamping unit 30 closes the mold to receive the molding material injected from the injection unit 20 into an inside of the mold. In this case, the mold clamping unit 30 clamps the mold by means of a clamping mechanism such that the mold does not open due to the filling of the molding material (mold clamping). A molding product is produced by solidifying the molding material filled in the mold. After that, the mold clamping unit 30 opens the mold and ejects the produced molding product. The mold clamping unit 30 performs, for example, a mold closing process, a pressure increasing process, a mold clamping process, a depressurizing process, a mold opening process, or the like in the manufacturing process of the molding product.

The control device 100 is a device that controls operations of the injection unit 20 and the mold clamping unit 30. The data processing device 200 is a device that processes data obtained as the injection unit 20 and the mold clamping unit 30 operate. The display unit 300 displays information related to the control of the injection unit 20 and the mold clamping unit 30 by the control device 100, data acquired by the data processing device 200, a processing result of the data processing device 200, and the like. In addition, the display unit 300 displays an operation screen for performing an operation to input commands or data to the control device 100 and the data processing device 200. In addition, the display unit 300 displays information of advice provided to a user. The molding supporting device 400 is a device that supports molding work by the user of the injection molding machine 10. Specifically, the molding supporting device 400 determines information of advice provided to the user and displays the information on the display unit 300. The information of the advice may be displayed on a display screen other than the display unit 300.

### CONFIGURATION OF CONTROL DEVICE 100

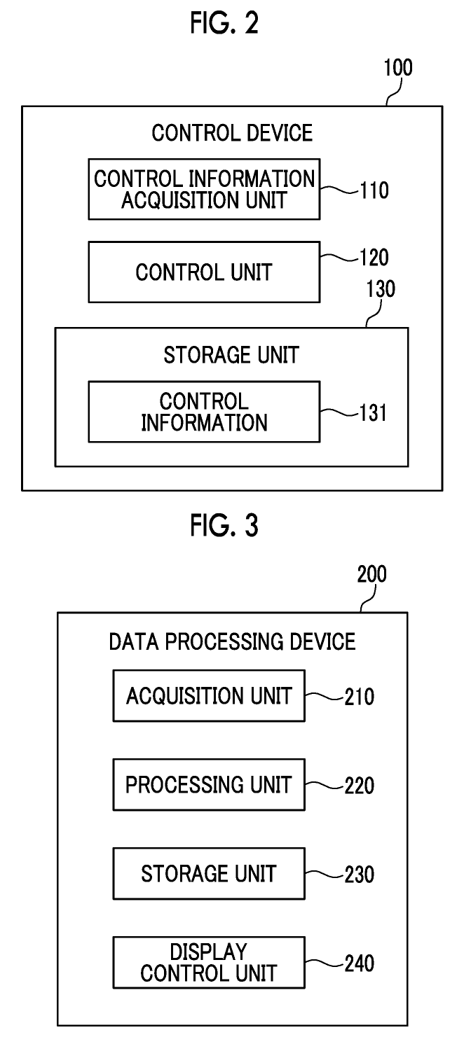

FIG. 2 is a view showing a configuration of the control device 100. The control device 100 controls operations of the injection unit 20 and the mold clamping unit 30. The control device 100 is realized by, for example, a computer. The control device 100 includes a control information acquisition unit 110, a control unit 120, and a storage unit 130. The control device 100 controls the injection unit 20 and the mold clamping unit 30 to repeatedly perform a process related to the manufacturing of the molding product, thereby repeatedly manufacturing the molding product. The process related to the manufacturing of the molding product includes a plasticizing process, a mold closing process, a pressure increasing process, a mold clamping process, a filling process, a pressure holding process, a cooling process, a depressurizing process, a mold opening process, an ejection process, and the like. Hereinafter, these processes related to the manufacturing may be collectively referred to as a "manufacturing process". In addition, a series of operations for obtaining a molding product, for example, an operation from the start of the plasticizing process in the above manufacturing process to the start of the next plasticizing process is referred to as a "shot", a "molding cycle", or the like. In addition, each of the above processes for manufacturing the molding product is merely an example. For example, as a process executed in one shot, another process not included in the above may be included.

The control information acquisition unit 110 acquires control information used to control the injection unit 20 and the mold clamping unit 30. The control information is a condition set by the user, and, for example, is input by the user using an input unit (not shown). For example, the control information includes molding conditions such as a resin temperature, a mold temperature (a cylinder temperature), an injection pressure holding time, a metering value, a V-P switching position, a pressure holding, an injection speed (a filling speed), a screw rotation speed, a screw back pressure, and a mold clamping force. A plurality of combinations of these molding conditions are determined depending on the molding product and the mold. Hereinafter, the combination data of the molding conditions will be also referred to as a molding condition data set. The control information acquisition unit 110 stores the acquired control information in the storage unit 130 as the molding condition data set.

The control unit 120 controls the injection unit 20 and the mold clamping unit 30 by using the above molding condition data set, and performs a process related to the manufacturing (shot) of the molding product including each of the above processes. The control unit 120 reads a molding condition data set corresponding to the molding product to be manufactured from the storage unit 130, for example, in a case where the manufacturing of the molding product starts. Then, the control unit 120 controls the operations of the injection unit 20 and the mold clamping unit 30 based on the read control information. Specifically, the control unit 120 controls the injection unit 20 and the mold clamping unit 30 such that the data obtained from the injection unit 20 and the mold clamping unit 30 in the manufacturing process matches a setting value of the molding condition data set. In addition, the control unit 120 may cause the display unit 300 to display the molding condition data set read from the storage unit 130. The user may refer to the data of the molding conditions displayed on the display unit 300 and may perform an operation such as correcting a value as necessary.

The storage unit 130 holds control information 131 acquired by the control information acquisition unit 110. The molding condition data set included in the control information 131 is prepared in association with a molding product to be manufactured and the mold. The storage unit 130 holds a molding condition data set for each molding product to be manufactured and each mold. In addition, although not shown, the storage unit 130 holds a program for the control unit 120 to control the injection unit 20 and the mold clamping unit 30. As will be described in detail later, the function of the control unit 120 is realized by a processor of the control device 100 reading and executing the program held in the storage unit 130.

### CONFIGURATION OF DATA PROCESSING DEVICE 200

FIG. 3 is a view showing a configuration of the data processing device 200. The data processing device 200 acquires and processes data obtained as the injection unit 20 and the mold clamping unit 30 execute operations in the process related to the manufacturing of the molding product. The data processing device 200 is realized by, for example, a computer. The data processing device 200 includes an acquisition unit 210, a processing unit 220, a storage unit 230, and a display control unit 240.

The acquisition unit 210 acquires data to be processed from the injection unit 20 and the mold clamping unit 30. Various sensors and detectors are attached to the injection unit 20 and the mold clamping unit 30. The data acquired by the sensors and the detectors (hereinafter, referred to as "acquisition data") is information representing a molding result of the injection unit 20 and the mold clamping unit 30, and is used for quality control of the molding product. Specifically, for example, the weight of the molding product, the dimensions of the molding product, the mold internal pressure, the minimum cushion position, and the feature values of the waveform of the filling pressure are included. The acquisition data is an actual value obtained in a manufacturing process of the molding product. The acquisition unit 210 receives the acquisition data transmitted from the sensor and the detector and stores the acquisition data in the storage unit 230.

The processing unit 220 processes the acquisition data stored in the storage unit 230. Specifically, the processing unit 220 performs processing of extracting a representative value of the acquisition data in each process and processing of generating time series data in which the acquisition data in each process is arranged in chronological order. In extracting the representative value, the processing unit 220 performs statistical processing such as calculating an average value, specifying a range of values, and specifying a maximum value or a minimum value on the acquisition data.

The storage unit 230 holds the representative value, the time series data, the statistical data, and the like, processed by the processing unit 220. The data is associated with, for example, the original acquisition data. Specifically, the data may be stored in a data file of the original acquisition data corresponding to the data. In addition, the data file in which data is stored may be associated with the data file of the original data. Accordingly, each piece of data generated by the processing unit 220 is also held in association with the molding product to be manufactured and the mold in the shot in which the original acquisition data is obtained. As the data format of the data file held in the storage unit 230, for example, comma-separated values (CSV), Extensible Markup Language (XML), JavaScript Object Notation (JSON), or the like can be used.

In addition, although not shown, the storage unit 230 holds a program for the processing unit 220 to execute data processing. As will be described in detail later, the processor of the data processing device 200 reads and executes the program held in the storage unit 230, so that functions of the processing unit 220 are realized.

The display control unit 240 causes the display unit 300 to display the acquisition data and the data of the processing result by the processing unit 220. The data to be displayed includes setting information in the control information used by the control device 100 to control the injection unit 20 and the mold clamping unit 30. The setting information (setting value) can be acquired from the control device 100. The display control unit 240 acquires the data from the storage unit 230 and the storage unit 130 of the control device 100 and causes the data to be displayed on the display unit 300.

### CONFIGURATION OF MOLDING SUPPORTING DEVICE 400

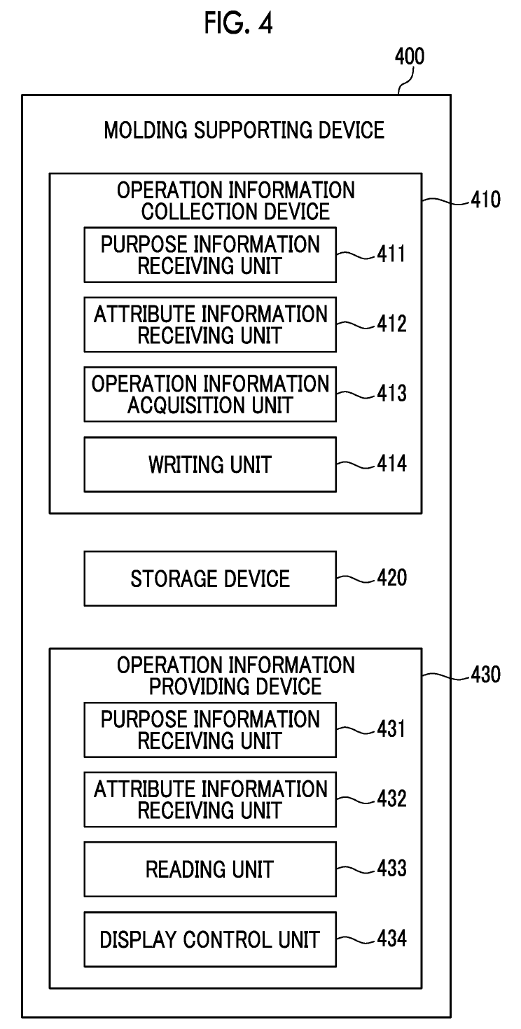

FIG. 4 is a view showing a configuration of the molding supporting device 400. The molding supporting device 400 includes an operation information collection device 410, a storage device 420, and an operation information providing device 430.

The operation information collection device 410 collects operation information indicating an operation on the control device 100. Here, the operation on the control device 100 is an operation performed on the control device 100 by a user (molding worker) in order to perform the molding work using the injection unit 20 and the mold clamping unit 30. Hereinafter, the "molding work" is simply referred to as "work", and the "molding worker" is simply referred to as "worker". The operation information collection device 410 includes a purpose information receiving unit 411, an attribute information receiving unit 412, an operation information acquisition unit 413, and a writing unit 414.

The purpose information receiving unit 411 receives purpose information indicating a purpose of work to be performed or a purpose of work performed in the past. Here, the purpose of the work is, for example, to resolve a certain molding defect, to appropriately determine a certain setting value, and the like. The purpose information receiving unit 411 may receive the purpose information in response to an operation performed by the worker to input the purpose of the work. Alternatively, the purpose information receiving unit 411 may receive the purpose information in response to an operation performed by a supervisor of the worker to input the purpose of the work via a management device (not shown). The management device is, for example, a device that manages the injection molding machine 10. Since it is sufficient that the operation information can be collected in association with the purpose of the work performed by the worker, the means is not limited as long as the purpose of the work of the worker can be understood. The purpose information receiving unit 411 is an example of a purpose information acquisition unit that acquires the purpose information indicating a purpose of the work with respect to the molding device.

The attribute information receiving unit 412 receives attribute information indicating an attribute of the work to be performed and an attribute of the work that has been performed. Here, first, the attributes of the work include an attribute of the work itself. The attribute of the work itself is, for example, information on a type of a mold, a screw, or a resin used for the work, information on a molding product obtained by the work, or the like. In addition, the attribute of the work includes an attribute of the worker. The attribute of the worker is, for example, information on the name, the position, and the skill level of the worker. Further, the attribute of the work also includes an attribute of a place where the work is performed. The attribute of the place where the work is performed is, for example, the name of the factory. The attribute of the work may be at least one of the attribute of the work itself, the attribute of the worker, and the attribute of the place where the work is performed. The attribute information receiving unit 412 may receive the attribute information in response to an operation of inputting the attribute information into an input field, an operation of selecting the attribute information from a pull-down menu, an operation of voice input, or the like. In addition, in a case where the attribute of the work is a mold or a screw, a QR code (registered trademark) or an RFID is attached to the mold or the screw. Then, the attribute information receiving unit 412 may receive the information on a combination of the mold and the screw by reading a QR code or the like with a reader provided in the control device 100. The attribute information receiving unit 412 is an example of an attribute information acquisition unit that acquires attribute information indicating the attribute of the work.

The operation information acquisition unit 413 acquires operation information indicating an operation performed by the worker to achieve the purpose of the work. For example, in a case where the purpose of the work is to resolve the molding defect, the operation performed by the worker refers to an operation until the molding defect is resolved. The operation information acquisition unit 413 may end acquisition of the operation information in a case where the problem is resolved and the worker declares the end of the operation. Alternatively, in a case where the operation is not performed for a certain period of time, the operation information acquisition unit 413 may end the acquisition of the operation information. In that case, the operation information acquisition unit 413 may regard the problem as having been resolved by the operation until no operation is performed for a certain period of time, and may regard the operation as an operation performed to resolve the problem. In addition, in that case, the purpose information receiving unit 411 may receive the purpose information and the attribute information receiving unit 412 may receive the attribute information after the operation information acquisition unit 413 acquires the operation information. The operation information acquisition unit 413 is an example of an operation information acquisition unit that acquires the operation information indicating an operation of the worker in the work.

The writing unit 414 writes the purpose information received by the purpose information receiving unit 411 and the attribute information received by the attribute information receiving unit 412 to the storage device 420. Then, the writing unit 414 writes the operation information acquired by the operation information acquisition unit 413 in association with the purpose information and the attribute information to the storage device 420. For example, the writing unit 414 writes the operation until the molding defect is resolved in association with the attribute of the work to the storage device 420, as long as the purpose of the work is to resolve the molding defect. The writing unit 414 may write negative information that a new problem has occurred in a case where a certain molding condition is changed in the storage device 420. The writing unit 414 is an example of a writing unit that writes the operation information acquired by the operation information acquisition unit in association with the purpose information acquired by the purpose information acquisition unit to the storage unit. In addition, the writing unit 414 is an example of a writing unit that writes the operation information to the storage unit in further association with the attribute information acquired by the attribute information acquisition unit.

The storage device 420 stores information written by the operation information collection device 410 and read by the operation information providing device 430. Specifically, the storage device 420 stores the purpose information, the attribute information, and the operation information written by the writing unit 414 in association with each other.

The operation information providing device 430 provides the past operation information for the purpose of the work as the information of the advice. The operation information providing device 430 includes a purpose information receiving unit 431, an attribute information receiving unit 432, a reading unit 433, and a display control unit 434.

The purpose information receiving unit 431 receives purpose information indicating a purpose of work to be performed. Here, the purpose of the work is, for example, to resolve a certain molding defect, to appropriately determine a certain setting value, and the like. The purpose information receiving unit 431 may receive the purpose information in response to an operation performed by the worker to input the purpose of the work. Alternatively, the purpose information receiving unit 431 may receive the purpose information in response to an operation performed by a supervisor of the worker to input the purpose of the work via a management device (not shown). The management device is, for example, a device that manages the injection molding machine 10. Since it is sufficient to provide operation information for the purpose of the work performed by the worker, the means is not limited as long as the purpose of the work of the worker can be understood.

The attribute information receiving unit 432 receives attribute information indicating an attribute of work required by the worker. Here, first, the attributes of the work include an attribute of the work itself. The attribute of the work itself is, for example, information on a type of a mold, a screw, or a resin used for the work, information on a molding product obtained by the work, or the like. In addition, the attribute of the work includes an attribute of the worker. The attribute of the worker is, for example, information on the name, the position, and the skill level of the worker. Further, the attribute of the work also includes an attribute of a place where the work is performed. The attribute of the place where the work is performed is, for example, the name of the factory. Then, the attribute of the work may be at least one of the attribute of the work itself, the attribute of the worker, and the attribute of the place where the work is performed. The attribute information receiving unit 432 may receive the attribute information in response to an operation of inputting the attribute information into an input field, an operation of selecting the attribute information from a pull-down menu, an operation of voice input, or the like. In addition, in a case where the attribute of the work is a mold or a screw, a QR code (registered trademark) or an RFID is attached to the mold or the screw. The attribute information receiving unit 432 may receive the information on a combination of the mold and the screw by reading a QR code or the like with a reader provided in the control device 100. Furthermore, the attribute information receiving unit 432 may count setting items that are changed in setting for the combination of the resin and the defect, and may receive the resin of the higher-level setting item as the attribute information. In this case, the attribute information receiving unit 432 may receive information managed by a resin supply device as information on the type of resin.

The reading unit 433 retrieves operation information from the storage device 420 based on the purpose information received by the purpose information receiving unit 431 and the attribute information received by the attribute information receiving unit 432. Then, the reading unit 433 reads the retrieved operation information from the storage device 420. In addition, the reading unit 433 may also read attribute information associated with the retrieved operation information from the storage device 420. Here, it is preferable that the attribute information received by the attribute information receiving unit 432 and the attribute information read by the reading unit 433 are different. For example, the former attribute information may be information on the molding product, and the latter attribute information may be information on the worker. The reading unit 433 is an example of a reading unit that reads, from a storage unit that stores the operation information indicating the operation of the worker in the work in association with the purpose information indicating the purpose of the work with respect to the molding device, the operation information associated with the purpose information. In addition, the reading unit 433 is an example of a reading unit that reads, from the storage unit that stores the operation information in further association with the attribute information indicating the attribute of the work, the attribute information associated with the operation information.

The display control unit 434 causes the display unit 300 to display the operation information read by the reading unit 433. Alternatively, the display control unit 434 may cause the display unit 300 to display derivation information derived from the operation information read by the reading unit 433. For example, the display control unit 434 may cause the display unit 300 to display information such as the order and the change range of the condition change until the problem is resolved in the past, and the screen that has been confirmed to provide the worker with the information. In this case, the display control unit 434 is an example of an output unit that outputs the operation information read by the reading unit or the derivation information derived from the operation information.

In this case, the display control unit 434 may cause the display unit 300 to display the attribute information read by the reading unit 433 in association with the operation information or the derivation information. In this case, the display control unit 434 is an example of an output unit that outputs the attribute information read by the reading unit in association with the operation information or the derivation information. In addition, the display control unit 434 is an example of an output unit that outputs the operation information or the derivation information by using the attribute information read by the reading unit.

For example, a case where the attribute information is the name, the position, the skill level, or the like of the worker is considered. In this case, the display control unit 434 may cause the display unit 300 to display information on who has performed the work or on the position or skill level of the person who has performed the work. Accordingly, the reliability of the displayed operation information or derivation information is increased, and the worker is more likely to adopt the operation information or the derivation information. Alternatively, the display control unit 434 may cause the display unit 300 to display that the operation is an operation performed in the past by a worker having a low skill level. The past operation includes, for example, what conditions the worker changed in the past and the change range in a case where the conditions are changed. In addition, the past operation also includes, for example, in what order the worker changes the screen to be displayed and in what order the worker performs setting changes. Furthermore, the past operation also includes, for example, problems newly generated by the setting changes and setting changes in which variations in logging are small. Accordingly, information such as a condition change that should not be performed or a large change range serves to narrow down options for the condition changes of the worker. Therefore, such information also becomes effective information for improving work efficiency. As a result, the display control unit 434 may cause the display unit 300 to display the condition that should not be changed in a grayed-out manner, or may cause the display unit 300 to hide the condition. The display control unit 434 may cause the display unit 300 to display the condition to be changed in a highlighted manner.

In addition, the display control unit 434 may cause the display unit 300 to display the derivation information derived from the operation information based on the attribute information read by the reading unit 433. In this case, the display control unit 434 is an example of an output unit that outputs the derivation information derived from the operation information based on the attribute information read by the reading unit. In addition, the display control unit 434 is an example of an output unit that outputs the operation information or the derivation information by using the attribute information read by the reading unit.

Here, the derivation information may be information obtained by narrowing down the operation information based on the attribute information.

For example, a case where the attribute information is the name, the position, the skill level, or the like of the worker is considered. In this case, the display control unit 434 causes the display unit 300 to display operation information narrowed down to a specific person. The specific person may be a person whom the worker trusts, a person whom the worker considers to have a high skill level, a person whom the worker wishes to refer to, and the like. In this manner, it is possible to know whose operation the derivation information is based on, that is, whether the derivation information is reliable. Therefore, it is expected that such information also has an effect of making it easier for the worker to adopt advice provided by the machine.

For example, a case where the attribute information is information indicating a factory having a high relevance to the machine or product currently being handled is considered. In this case, the display control unit 434 derives the derivation information associated with the factory, that is, collected in a certain limited range such as inside the factory, from the operation information.

In addition, the derivation information may be differential information of the operation information for each piece of attribute information. The differential information is information indicating a difference between the operation information associated with an attribute value of the attribute information and the operation information associated with another attribute value of the attribute information. In this manner, it can be understood that work is performed by one person but not by another person, or that certain work is performed by a person with a high skill level but not by a person with a low skill level.

Furthermore, the display control unit 434 may cause the display unit 300 to display the derivation information, which is a result of machine learning performed on the operation information read by the reading unit 433. As a result, useful advice for improving work efficiency is provided. In this case, the display control unit 434 is an example of an output unit that outputs the derivation information which is a result of machine learning performed on the operation information.

Furthermore, the display control unit 434 may cause the display unit 300 to display information indicating the amount of the operation information read by the reading unit 433. This is for the purpose of enabling the worker to understand the number of pieces of operation information on which the provided advice is based, thereby allowing the worker to determine the reliability of the information. Alternatively, the display control unit 434 may cause the display unit 300 to display information indicating the amount of operation information for each attribute. In this case, the display control unit 434 is an example of an output unit that further outputs the information indicating the amount of operation information.

### HARDWARE CONFIGURATION OF COMPUTER REALIZING CONTROL DEVICE 100, DATA PROCESSING DEVICE 200, AND MOLDING SUPPORTING DEVICE 400

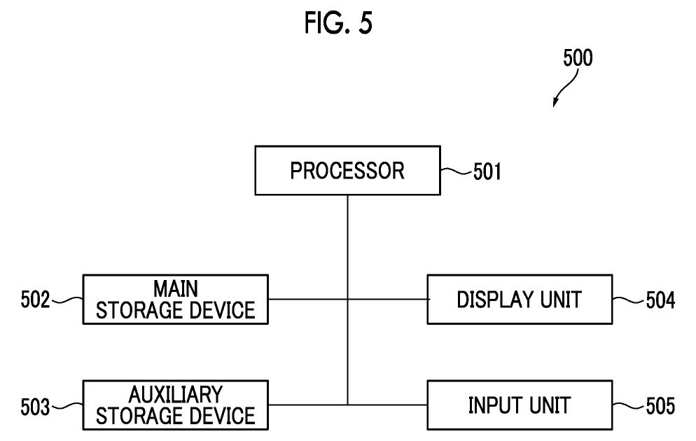

FIG. 5 is a view showing a hardware configuration example of a computer 500 that realizes a control device 100, a data processing device 200, and a molding supporting device 400. The computer 500 shown in FIG. 5 includes a processor 501 serving as a calculation means, and a main storage device (main memory) 502 and an auxiliary storage device 503 serving as storage means. As the processor 501, for example, various calculation circuits such as a central processing unit (CPU), a graphics processing unit (GPU), an application-specific integrated circuit (ASIC), and a field-programmable gate array (FPGA) are used. The processor 501 reads a program stored in the auxiliary storage device 503 into the main storage device 502 and executes the program. For example, a random-access memory (RAM) is used as the main storage device 502. For example, a magnetic disk device, a solid-state drive (SSD), or the like is used as the auxiliary storage device 503.

In addition, the computer 500 includes a display unit (display) 504 and an input unit 505 through which a user performs an input operation. For example, a keyboard, a mouse, or the like is used as the input unit 505. Further, a touch panel configured integrally with the display unit 504 may be used as the input unit 505. The display unit 504 may be realized by the display unit 300 shown in FIG. 1. In addition, a configuration of the computer 500 shown in FIG. 5 is merely an example, and the computer 500 used in the present embodiment is not limited to the configuration example of FIG. 5. For example, the configuration may include a non-volatile memory such as a flash memory, or a read-only memory (ROM) may be provided as the storage device.

In a case where the control device 100 is realized by the computer shown in FIG. 5, the control information acquisition unit 110 is realized by, for example, the processor 501 that reads and executes the program and the input unit 505. The function of the control unit 120 is realized, for example, by the processor 501 reading and executing the program. The storage unit 130 is realized by, for example, the auxiliary storage device 503.

In a case where the data processing device 200 is realized by the computer shown in FIG. 5, the functions of the acquisition unit 210 and the processing unit 220 are realized by, for example, the processor 501 reading and executing the program. The storage unit 230 is realized by, for example, the auxiliary storage device 503. The display control unit 240 is realized by the processor 501 that reads and executes the program.

In a case where the molding supporting device 400 is realized by the computer 500 shown in FIG. 5, the functions of the operation information collection device 410 and the operation information providing device 430 are realized by, for example, the processor 501 reading and executing the program. The storage device 420 is realized by, for example, the auxiliary storage device 503.

### OPERATION INFORMATION COLLECTION PROCESSING

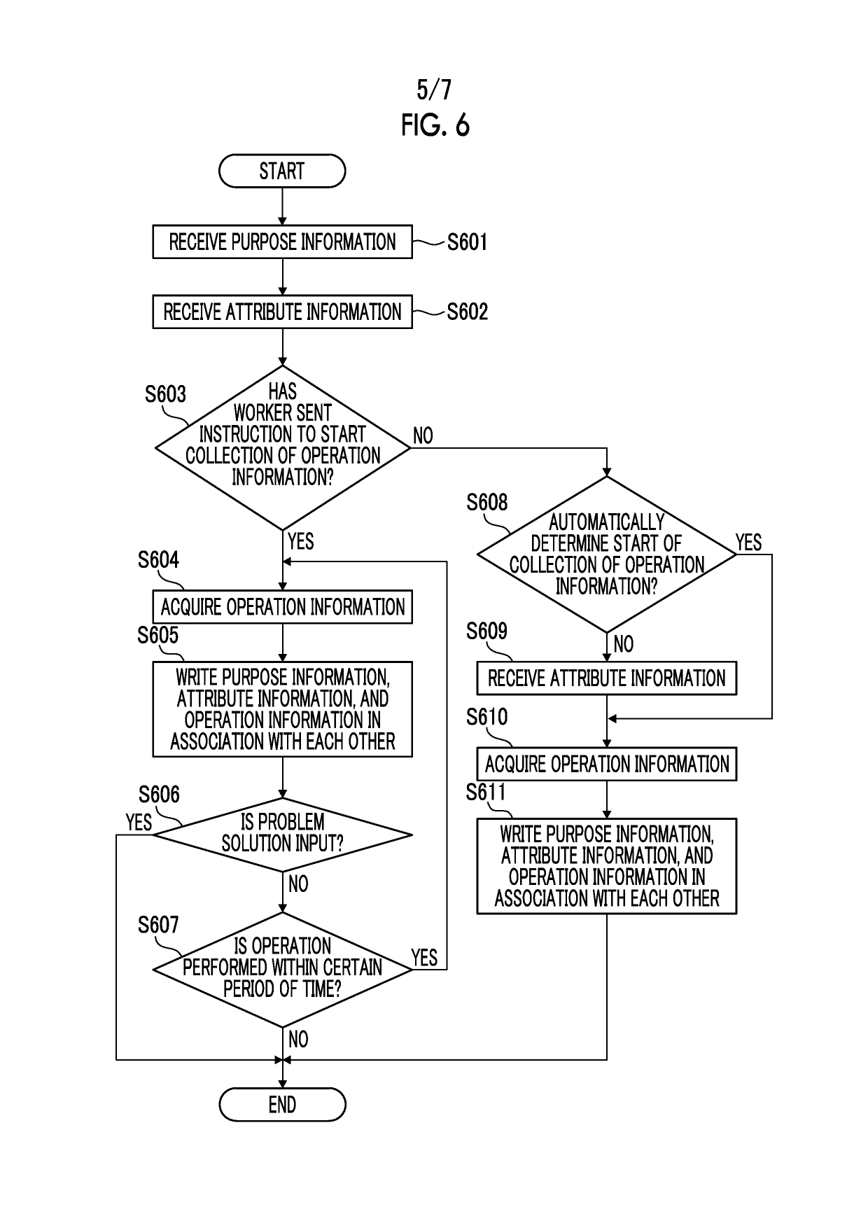

FIG. 6 is a view showing an example of a flow of operation information collection processing performed by the operation information collection device 410.

In FIG. 6, first, the purpose information receiving unit 411 receives purpose information indicating a purpose of work to be performed (Step S601). The purpose information receiving unit 411 may receive, for example, the purpose information in response to an operation performed by the worker to input the purpose of the work.

Next, the attribute information receiving unit 412 receives attribute information indicating an attribute of the work to be performed (Step S602). For example, the attribute information receiving unit 412 may receive the attribute information in response to an operation performed by the worker to input the attribute of the work.

Next, the operation information collection device 410 determines whether or not the worker has sent an instruction to start collection of the operation information (Step S603).

First, a case where the worker sends the instruction to start the collection of the operation information will be described.

In this case, first, the operation information acquisition unit 413 acquires the operation information indicating the operation performed by the worker (Step S604).

Next, the writing unit 414 acquires the purpose information received in Step S601, the attribute information received in Step S602, and the operation information acquired in Step S604. Then, the writing unit 414 writes the above pieces of information, in association with each other, to the storage device 420 (Step S605).

Thereafter, the operation information collection device 410 determines whether or not a problem resolution is input by the worker (Step S606).

In a case where the problem resolution is input by the worker, the operation information collection device 410 ends the operation information collection processing.

On the other hand, in a case where the problem resolution is not input by the worker, the operation information collection device 410 determines whether or not any operation is performed by the worker within a certain period of time up to the present (Step S607).

In a case where no operation is performed by the worker within the certain period of time, the operation information collection device 410 determines that the problem is resolved, and ends the operation information collection processing.

On the other hand, in a case where an operation is performed by the worker within the certain period of time, the operation information collection device 410 returns the processing to Step S604 and continues the operation information collection processing.

Next, a case where the worker does not send an instruction to start collection of the operation information will be described.

In this case, first, the operation information collection device 410 determines whether or not to automatically determine the start of collection of the operation information (Step S608).

In a case where the start of the collection of the operation information is not automatically determined, first, the attribute information receiving unit 412 receives the attribute information indicating the attribute of the work (Step S609). For example, the attribute information receiving unit 412 may receive the attribute information in response to an operation performed by the worker to input the attribute of the work.

Next, the operation information acquisition unit 413 acquires the operation information indicating a series of operations performed by the worker (Step S610). Here, the operation information acquisition unit 413 may execute this processing only in a case where the attribute information received in Step S609 coincides with the attribute information received in Step S602.

Next, the writing unit 414 acquires the purpose information received in Step S601, the attribute information received in Step S602, and the operation information acquired in Step S610. Then, the writing unit 414 writes the above pieces of information, in association with each other, to the storage device 420 (Step S611).

On the other hand, in a case where the start of the collection of the operation information is automatically determined, first, the operation information acquisition unit 413 acquires the operation information indicating the series of operations performed by the worker (Step S610). Here, the operation information acquisition unit 413 may execute this processing only in a case where the automatically detected attribute information coincides with the attribute information received in Step S602. The automatically detected attribute information is, for example, information on a type of the resin obtained from the resin supply device.

Next, the writing unit 414 acquires the purpose information received in Step S601, the attribute information received in Step S602, and the operation information acquired in Step S610. Then, the writing unit 414 writes the above pieces of information, in association with each other, to the storage device 420 (Step S611).

In FIG. 6, the operation information collection device 410 acquires the operation information after receiving the purpose information. However, the present invention is not limited thereto. The operation information collection device 410 may receive the purpose information after acquiring the operation information.

In addition, in FIG. 6, the operation information collection device 410 acquires the operation information after receiving the attribute information. However, the present invention is not limited thereto. The operation information collection device 410 may receive the attribute information after acquiring the operation information.

### OPERATION INFORMATION PROVIDING PROCESSING

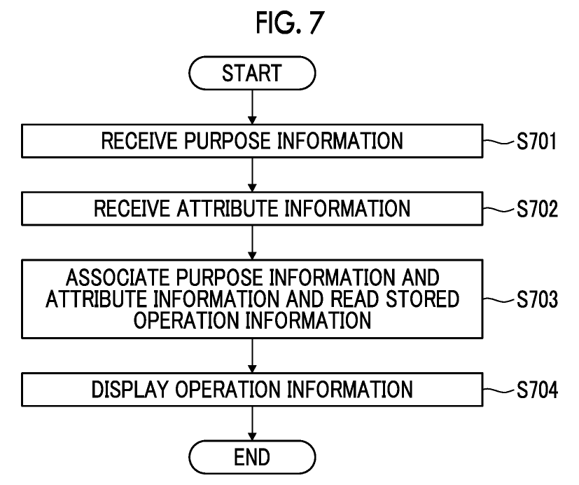

FIG. 7 is a view showing an example of a flow of operation information providing processing performed by the operation information providing device 430.

In FIG. 7, first, the purpose information receiving unit 431 receives purpose information indicating a purpose of work to be performed (Step S701). The purpose information receiving unit 431 may receive, for example, the purpose information in response to an operation performed by the worker to input the purpose of the work.

Next, the attribute information receiving unit 432 receives attribute information indicating the attribute of the work required by the worker (Step S702). For example, the attribute information receiving unit 432 may receive the attribute information in response to an operation performed by the worker to input the attribute of the required work.

Next, the reading unit 433 acquires the purpose information received in Step S701 and the attribute information received in Step S702. Then, the reading unit 433 reads the operation information stored in the storage device 420 in association with these (Step S703).

Thereafter, the display control unit 434 causes the display unit 300 to display the operation information read in Step S703 (Step S704).

In FIG. 7, the display control unit 434 causes the display unit 300 to display the operation information in Step S704. However, the present invention is not limited thereto. In Step S704, the display control unit 434 may cause the display unit 300 to display the derivation information derived from the operation information.

In addition, in FIG. 7, the reading unit 433 is configured to read only the operation information in Step S703, but the present invention is not limited thereto. In Step S703, the reading unit 433 may read the attribute information stored in the storage device 420 in association with the operation information, in addition to the operation information. Here, it is preferable that the attribute information received in Step S702 and the attribute information read in Step S703 are different from each other. For example, the former attribute information may be information on the molding product, and the latter attribute information may be information on the worker.

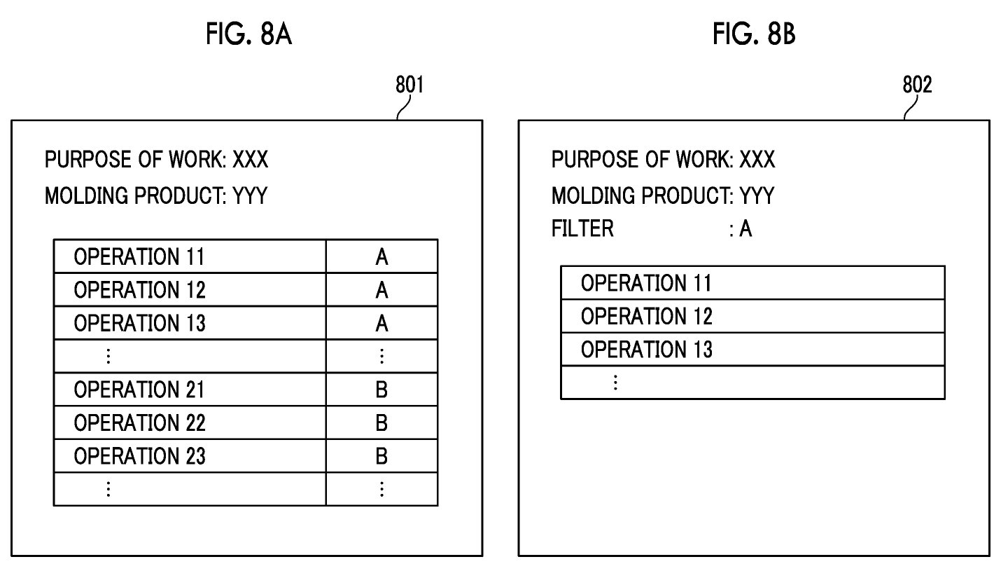

Then, in Step S704, the display control unit 434 may cause the display unit 300 to display the attribute information read in Step S703 in association with the operation information or the derivation information. FIG. 8A is a view showing a screen 801 displayed on the display unit 300 in this case. On the screen 801, attribute information A is associated with and displayed for operations 11, 12, 13, and the like, and attribute information B is associated with and displayed for operations 21, 22, 23, and the like. The attribute information A and B may be, for example, names of persons.

In addition, in Step S704, the display control unit 434 may cause the display unit 300 to display the derivation information obtained by narrowing down the operation information based on the attribute information read in Step S703. FIG. 8B is a view showing a screen 802 displayed on the display unit 300 in this case. On the screen 802, as a result of the operation information being narrowed down based on the attribute information A, the operations 11, 12, 13, and the like are displayed. The attribute information A may be, for example, names of persons.

### SUMMARY

In the present embodiment, effects such as a reduction in the working time required to resolve problems such as molding defects and a decrease in the number of defective shots can be expected. In addition, in the present embodiment, the know-how possessed by a certain person, the know-how unique to the factory or the molding site, the know-how specific to each mold, and the like are provided to the worker via the injection molding machine 10. Accordingly, the effect of naturally passing down technical skills can be expected.

Although the embodiment of the present invention has been described above, the technical scope of the present invention is not limited to the above embodiment.

For example, in the above embodiment, the operation information collection device 410 collects the operation information and then the operation information providing device 430 provides the operation information. However, the present invention is not limited thereto. While the operation information collection device 410 collects the operation information, the operation information providing device 430 may provide the operation information collected in the past.

In addition, in the above embodiment, all the functions of the molding supporting device 400 are realized by the device in the injection molding machine 10, but the present invention is not limited thereto.

For example, all the functions of the molding supporting device 400 may be realized by a terminal device such as a PC, a smartphone, or a tablet connected to the injection molding machine 10 via a communication line. Alternatively, all the functions of the molding supporting device 400 may be realized by a server computer connected to the injection molding machine 10 via the communication line.

In addition, some functions of the molding supporting device 400 may be realized by the device in the injection molding machine 10 or a terminal device, and other parts of the functions of the molding supporting device 400 may be realized by a server computer.

Specifically, the purpose information receiving unit 411, the attribute information receiving unit 412, and the operation information acquisition unit 413 may be realized by the device in the injection molding machine 10 or the terminal device. In addition, the writing function of the writing unit 414, the storage device 420, and the reading unit 433 may be realized by the server computer. Furthermore, the purpose information receiving unit 431, the attribute information receiving unit 432, and the display control unit 434 may be realized by the device in the injection molding machine 10 or the terminal device.

On the other hand, the function of associating with the writing unit 414 may be realized by the device in the injection molding machine 10 or the terminal device, or may be realized by the server computer.

In the former case, the purpose information, the attribute information, and the operation information are associated with the device in the injection molding machine 10 or the terminal device. In this case, a function of associating the purpose information and the operation information with each other is an example of a generation unit that generates association information in which the purpose information indicating the purpose of the work for the molding device and the operation information indicating the operation of the worker in the work are associated with each other.

In addition, the association information in which the purpose information, the attribute information, and the operation information are associated with each other is considered to be temporarily held in a volatile memory in the device in the injection molding machine 10 or the terminal device. In this case, the function of holding the association information in the volatile memory is an example of a writing unit that writes the operation information acquired by the operation information acquisition unit in association with the purpose information acquired by the purpose information acquisition unit, to the storage unit. In addition, the function of holding the association information in the volatile memory is also an example of a writing unit that writes the operation information to the storage unit in further association with the attribute information acquired by the attribute information acquisition unit.

Furthermore, the association information in which the purpose information, the attribute information, and the operation information are associated with each other is received by the server computer and written to the storage device 420. In this case, the function of receiving the association information is an example of an acquisition unit that acquires the association information in which the purpose information indicating the purpose of the work for the molding device and the operation information indicating the operation of the worker in the work are associated with each other. In addition, the function of writing the association information to the storage device 420 is an example of a writing unit that writes the association information acquired by the acquisition unit to the storage unit.

In the latter case, the purpose information, the attribute information, and the operation information are associated with each other by the server computer and written to the storage device 420. In this case, a function of associating the purpose information and the operation information with each other is an example of a generation unit that generates association information in which the purpose information indicating the purpose of the work for the molding device and the operation information indicating the operation of the worker in the work are associated with each other.

Furthermore, the above embodiment is applied to the work in the injection molding machine 10, but is not limited thereto. The above embodiment may be applied to work in peripheral units other than the injection molding machine 10. Here, examples of the peripheral unit include a temperature controller, a resin dryer, a crusher, a take-out machine, and the like.

It should be understood that the invention is not limited to the above-described embodiment, but may be modified into various forms on the basis of the spirit of the invention. Additionally, the modifications are included in the scope of the invention.

What is claimed is:

1. A molding supporting device comprising:
a purpose information acquisition unit that acquires purpose information indicating a purpose of work with respect to a molding device;
an operation information acquisition unit that acquires operation information indicating an operation of a worker in the work; and
a writing unit that writes the operation information acquired by the operation information acquisition unit in association with the purpose information acquired by the purpose information acquisition unit to a storage unit.

2. The molding supporting device according to claim 1, further comprising:
an attribute information acquisition unit that acquires attribute information indicating an attribute of the work,
wherein the writing unit writes the operation information in further association with the attribute information acquired by the attribute information acquisition unit to the storage unit.

3. The molding supporting device according to claim 1,
wherein the purpose information acquisition unit receives the purpose information in response to an operation performed by the worker to input the purpose of the work.

4. The molding supporting device according to claim 1,
wherein the purpose information acquisition unit receives the purpose information in response to an operation performed by a supervisor of the worker to input the purpose of the work via a management device.

5. The molding supporting device according to claim 1, further comprising:
an operation information providing device that provides past operation information for the purpose of the work as information of advice.

6. The molding supporting device according to claim 2,
wherein the attribute information indicates at least one of an attribute of the work itself, an attribute of the worker, and an attribute of a place where the work is performed.

7. A molding supporting device comprising:
a reading unit that reads, from a storage unit that stores operation information indicating an operation of a worker in work with respect to a molding device in association with purpose information indicating a purpose of the work, the operation information associated with the purpose information; and
an output unit that outputs the operation information read by the reading unit or derivation information derived from the operation information.

8. The molding supporting device according to claim 7,
wherein the reading unit reads, from the storage unit that stores the operation information in further association with attribute information indicating an attribute of the work, the attribute information associated with the operation information, and
the output unit outputs the operation information or the derivation information by using the attribute information read by the reading unit.

9. The molding supporting device according to claim 8,
wherein the attribute information indicates at least one of an attribute of the work itself, an attribute of the worker, and an attribute of a place where the work is performed.

10. The molding supporting device according to claim 8,
wherein the output unit outputs the attribute information read by the reading unit in association with the operation information or the derivation information.

11. The molding supporting device according to claim 8,
wherein the output unit outputs the derivation information derived from the operation information, based on the attribute information read by the reading unit.

12. The molding supporting device according to claim 7,
wherein the output unit outputs the derivation information which is a result of machine learning performed on the operation information.

13. The molding supporting device according to claim 7,
wherein the output unit further outputs information indicating an amount of the operation information.

14. A molding machine comprising:
the molding supporting device according to claim 1;
the molding device; and
a control device that controls the molding device.

15. A molding supporting device comprising:
an acquisition unit that acquires association information in which purpose information indicating a purpose of work with respect to a molding device and operation information indicating an operation of a worker in the work are associated with each other; and
a writing unit that writes the association information acquired by the acquisition unit to a storage unit.
